(19) United States
(12) Patent Application Publication
(10) Pub. No.: US 2017/0232707 A1
(43) Pub. Date: Aug. 17, 2017

(54) CUSTOM PRINTABLE CONFETTI

(71) Applicant: Blank Acquisition, LLC d/b/a Blanks/USA, Brooklyn Park, MN (US)

(72) Inventor: Andrew R. Ogren, Woodbury, MN (US)

(21) Appl. No.: 15/042,888

(22) Filed: Feb. 12, 2016

(51) Int. Cl. B32B 7/12; B32B 27/36; B32B 27/30

(52) U.S. Cl. CPC B32B 7/12; B32B 27/304; B32B 27/36; B32B 2307/75; B32B 2323/10; B32B 2323/04

(57) ABSTRACT

A printable sheet includes a plurality of confetti pieces, a printable substrate layer, a backing film layer, a dry lift adhesive layer, and cut lines. The dry lift adhesive layer connects the printable substrate layer to the backing film layer. The backing film layer is separable from the substrate layer along the dry lift adhesive layer. The cut lines define the confetti pieces and extend through the printable substrate layer and the dry lift adhesive layer, but not through the backing film layer.

### BACKGROUND

Custom print materials have become a common convenience for consumers. Custom print materials can include advertising materials, packaging, and decorative materials. Some products used in advertising include postcards, flyers, and door hangers, and some products used in packaging include products like golf ball boxes, candy boxes and pop-up calendars. Decorative materials can range from simple colored or printable sheets to complex arrangements assembled from multiple printed pieces. Typically, custom print materials are sent to print shops that specialize in preparing custom print materials, as the materials have had to be printed and assembled by special machines. And, often print shops require that orders be placed in large quantities. As a result, printable custom print materials can be costly and time-consuming.

Some printable blank templates are currently available for creating custom print materials without having to send them to print shops. A drawback to some of the currently available templates is that the printed objects are hard to detach from their excess sheet. Perforations are a feature commonly used in templates for detachment. These perforations are often placed irregularly relative to the printed objects, making folding along the perforations difficult, resulting in a failure to weaken perforations. Trying to separate the perforated lines before weakening them can be time consuming and can cause tearing of the printed object, which affects the strength and image of the resulting a separated printed object.

### SUMMARY

A printable sheet includes a plurality of confetti pieces, a printable substrate layer, a backing film layer, a dry lift adhesive layer, and cut lines. The dry lift adhesive layer connects the printable substrate layer to the backing film layer. The backing film layer is separable from the printable substrate layer along the dry lift adhesive layer. The cut lines define the confetti pieces and extend through the printable substrate layer and the dry lift adhesive layer, but not through the backing film layer.

A printable sheet includes a plurality of confetti pieces, a first printable side and a second printable side, outline perforations, and run-out perforations. Outline perforations extend through the printable sheet, and define confetti pieces. The run-out perforations extend from the outline perforations to edges of the printable sheet.

A method of creating confetti pieces using a printable sheet includes running a printable sheet through a printer. The printable sheet includes a printable substrate layer that is attached to a backing film layer with a dry lift adhesive. The sheet has cut lines defining confetti pieces and extending through the printable substrate layer and the dry lift adhesive layer but not through the backing film layer. A notch of the printable substrate layer can be lifted. The notch is adjacent an edge of the printable sheet, and is connected to the backing film layer. The backing film layer and dry lift adhesive can be peeled away from the printable substrate layer, separating the confetti pieces from one another.

A method of creating confetti pieces using a printable sheet includes running a printable sheet through a printer. The printable sheet includes a first printable side and a second printable side. The printable sheet also includes outline perforations through the printable sheet that define confetti pieces, and run-out perforations extending from the outline perforations to edges of the printable sheet. The printable sheet can be bent along the outline perforations. The printable sheet can be torn along the outline perforations causing the confetti pieces to separate from one another.

### BRIEF DESCRIPTION OF THE DRAWINGS

FIG. 1 is a plan view of a first embodiment of a printable sheet of confetti pieces.

FIG. 2 is a cross-sectional view of a portion of the first embodiment of the printable sheet of FIG. 1.

FIG. 3 is a cross-sectional elevation view of a portion of the first embodiment of the printable sheet of FIG. 1 showing a cut line.

FIG. 4A is a plan view of a first embodiment of a dry lift adhesive applied in a first laminating pattern.

FIG. 4B is a plan view of a second embodiment of the dry lift adhesive applied in a second laminating pattern.

FIG. 4C is a plan view of a third embodiment of the dry lift adhesive applied in a third laminating pattern.

FIG. 5 is a plan view of the first embodiment of the printable sheet of FIG. 1 with printed images on the confetti pieces.

FIG. 6 is a flow chart showing how printable confetti pieces can be created from the first embodiment of the printable sheet.

FIG. 7 is a perspective view of the first embodiment of the printable sheet as the printable sheet is run through a printer.

FIG. 8 is a perspective view of the first embodiment of the printable sheet as a corner of a backing film layer is lifted.

FIG. 9 is a perspective view of the first embodiment of the printable sheet as the backing film layer is peeled off the printable sheet.

FIG. 10 is a perspective view of the first embodiment of the printable sheet with the backing film layer removed and confetti pieces partially removed from the printable sheet.

FIG. 11 is a plan view of confetti pieces after they have been removed from the first embodiment of the printable sheet.

FIG. 12 is a plan view of the first embodiment of the printable sheet with confetti pieces having different geometric shapes.

FIG. 13 is an enlarged view of a portion of FIG. 12 showing a tie connecting a confetti piece to a remainder of a printable substrate layer.

FIG. 14 is a plan view of a second embodiment of a printable sheet of confetti pieces that is printable on both sides of the printable sheet.

FIG. 15 is a flow chart showing how confetti pieces can be created from the second embodiment of the printable sheet.

FIG. 16 is a side elevation view of the second embodiment of the printable sheet that is folded along run-out perforations.

### DETAILED DESCRIPTION

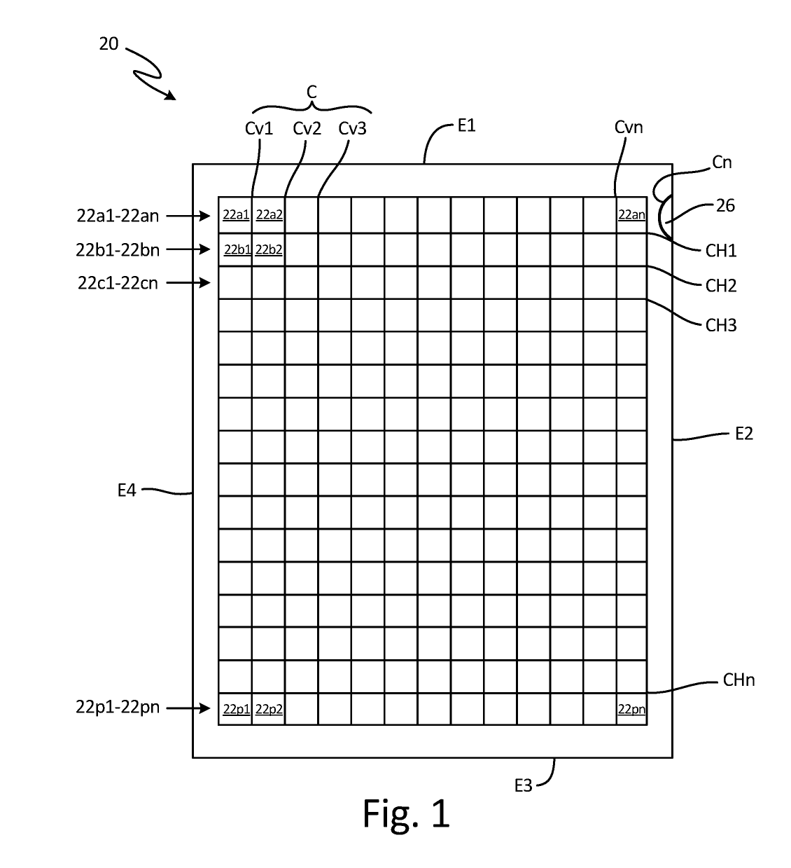

FIG. 1 is a plan view of a first embodiment of printable sheet 20, which includes confetti pieces 22, remainder 24, notch 26, notch cut line CN, edges E1-E4, and cut lines C. Cut lines C include horizontal cut lines CH1-CHn and vertical cut lines CV1-CVn. Confetti pieces 22 include rows of confetti pieces (22a1-22an, 22b1-22bn, 22c1-22cn . . . 22p1-22pn).

Printable sheet 20 is a flat rectangular sheet of paper or other substance capable of being run through a printer and capable of receiving printable material. Printable sheet 20 includes a plurality of layers including a printable substrate layer connected to a backing film layer with a dry lift adhesive. Printable sheet 20 is comprised of confetti pieces 22 that are small removable pieces of printable sheet 20. In the embodiment shown in FIG. 1, confetti pieces 22 have the shape of squares from a plan view perspective. Confetti pieces 22 are created by cut lines C, which are physical cuts extending at least partially through printable sheet 20. In one embodiment, cut lines C extend through a printable substrate layer and a dry lift adhesive layer of printable sheet 20, but not through a backing film layer of printable sheet 20.

Horizontal cut lines CH1-CHn are parallel to each other and to edges E1 and E3, and span from near edge E2 to near edge E4. Vertical cut lines CV1-CVn are parallel to each other and to edges E2 and E4, and span from near edge E1 to near edge E3. Horizontal cut lines CH1-CHn are perpendicular to vertical cut lines CV1-CVn, and together form the periphery of all of confetti pieces 22. For example, horizontal cut lines CH1 and CH2 individually cross both of vertical cut lines CV1 and CV2 forming the periphery of confetti piece 22a1.

Horizontal cut lines CH1-CHn and vertical cut lines CV1-CVn also form remainder 24 of printable sheet 20. For example, horizontal cut line CH1 forms a portion of remainder 24 near edge E1. Remainder 24 surrounds confetti pieces 22, which define the inner border of remainder 24. The outer border or perimeter of remainder 24 is defined by edges E1-E4.

Notch cut line CN is an arcuate cut that passes at least partially through printable sheet 20. Notch cut line CN begins at edge E2, arcs into printable sheet 20 towards confetti pieces 22 and arcs back to edge E2 where notch cut line CN terminates. Notch cut line CN together with edge E2 form the periphery of notch 26. Notch 26 is connected to the backing film layer of printable sheet 20, but is separated from remainder 24 by notch cut line CN. In another embodiment, notch cut line CN can be a plurality of cut lines forming an angular notch 26. In yet another embodiment, printable sheet 20 can include a plurality of notches 26.

In use of one embodiment, printable sheet 20 can be fed through a printer (not shown in FIG. 1) from which confetti pieces 22 can be printed on. Then a user can grasp notch 26 and pull notch 26 and the backing film layer to which notch 26 is connected, which will separate the lower layer of printable sheet 20 from confetti pieces 22 and remainder 24. Confetti pieces 22 then separate from remainder 24 of printable sheet 20, as cut lines C surrounding confetti pieces 22 are cut through the printable substrate. Using notch 26 to separate confetti pieces 22 from the backing film layer allows a user to remove confetti pieces 22 from printable sheet 20 quickly and efficiently. It also prevents confetti pieces 22 from being torn or damaged when they are removed from printable sheet 20.

When confetti pieces 22 are removed from printable sheet 20, they are made out of the printable substrate layer of printable sheet 20. The printable substrate can include a film layer, which strengthens confetti pieces 22.

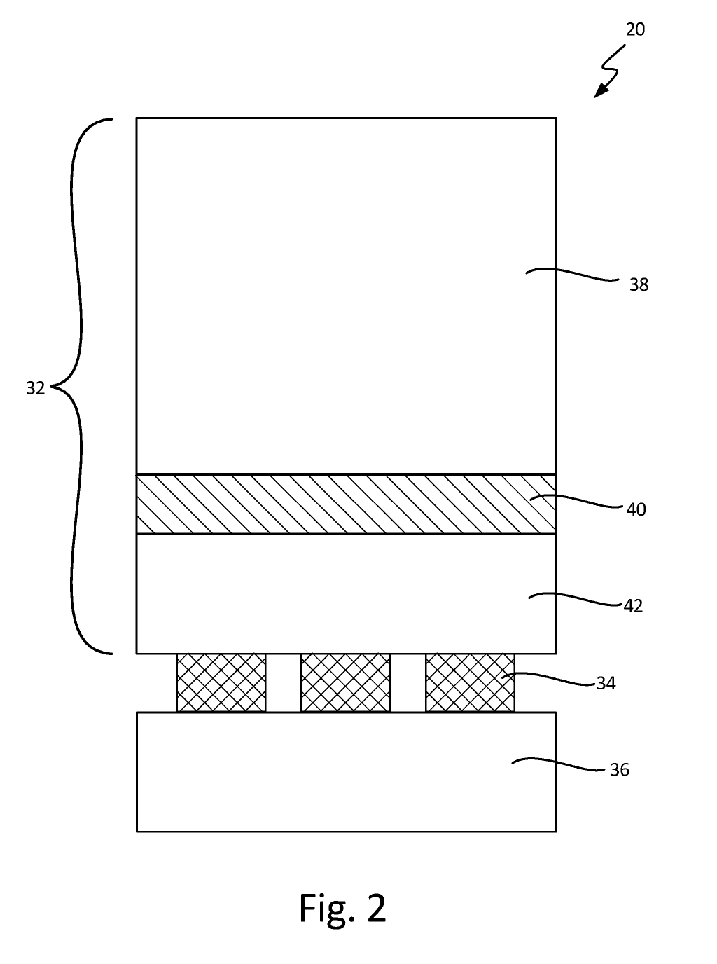

FIG. 2 is a cross-sectional view of printable sheet 20, showing the layers of printable sheet 20. Printable sheet 20 includes printable substrate 32, dry lift adhesive 34, and backing film layer 36. Printable substrate 32 includes top substrate layer 38, pressure sensitive adhesive 40, and film layer 42.

Printable substrate 32 has a top face that is exposed, or unconnected to any other portion of printable sheet 20. A bottom face of top substrate layer 38 is connected to a top face of film layer 42 with pressure sensitive adhesive 40. A bottom face of film layer 42 (the bottom face of substrate layer 32) is connected to a top face of backing film layer 36 with dry lift adhesive 34. In alternate embodiments, printable substrate 32 can include different or more layers, as long as printable sheet 20 is capable of passing through a printer.

Top substrate layer 38 forms the topmost layer of printable sheet 20. Top substrate layer 38 is a paper layer in the embodiment shown, but can also be a synthetic material in alternate embodiments, such as polyester (PET), polypropylene, vinyl, other printable synthetic materials, or any other printable material.

Film layer 42 forms the middle layer of printable sheet 20. Film layer 42 is biaxially oriented polypropolyene (BOPP) in the embodiment shown, but can be any suitable film in alternate embodiments, including polyethelyene (PE), polyester (PET), and polyvinyl chloride (PVC).

Pressure sensitive adhesive 40 connects a bottom face of top substrate layer 38 to a top face of film layer 42. Pressure sensitive adhesive 40 is a pressure-activated adhesive that forms a bond between top substrate layer 38 and film layer 42 when the layers are pressed together.

Top substrate layer 38, pressure sensitive adhesive 40, and film layer 42 form printable substrate 32. Printable substrate 32 can have a thickness between 0.004 inches (0.1016 millimeters) and 0.018 inches (0.4572 millimeters).

Backing film layer 36 forms the bottom layer of printable sheet 20. Backing film layer 36 is biaxially oriented polypropolyene (BOPP) in the embodiment shown, but can be any suitable film in alternate embodiments, including polyethelyene (PE), polyester (PET), and polyvinyl chloride (PVC). Backing film layer 36 can have a thickness between 0.0005 inches (0.0127 millimeters) and 0.004 inches (0.1016 millimeters).

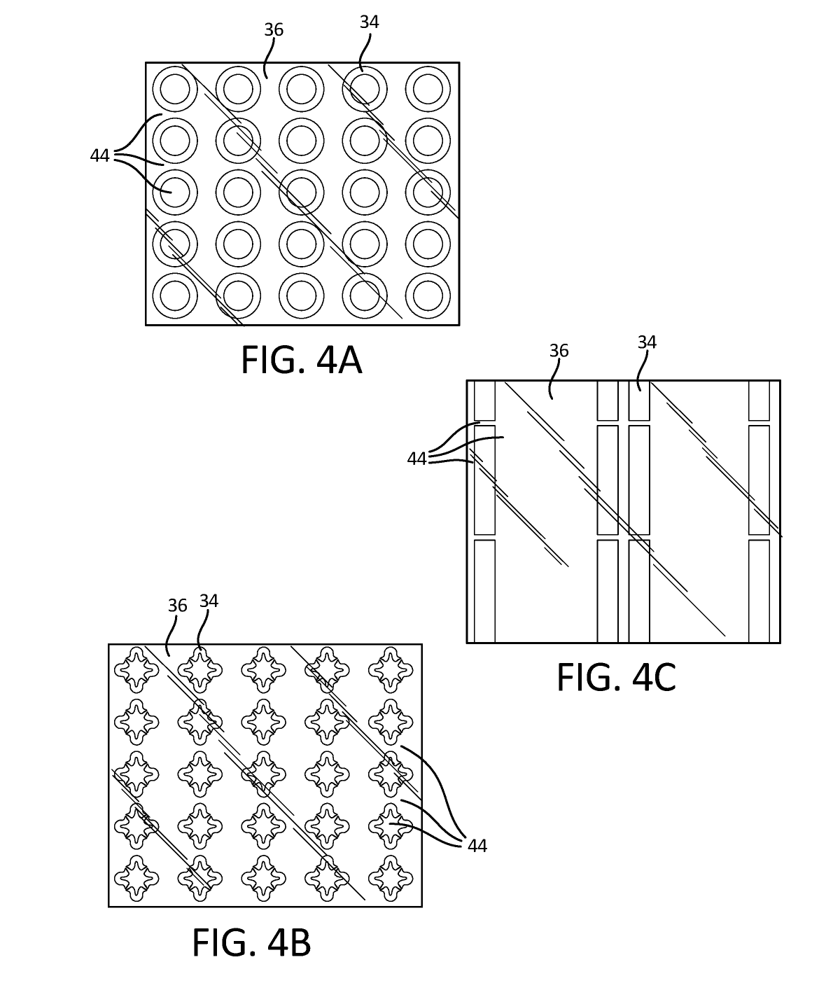

Dry lift adhesive 34 connects a bottom face of film layer 42 (the bottom face of printable substrate 32) to a top face of backing film layer 36. Dry lift adhesive 34 can be a strong adhesive that can be applied in a pattern so that there are areas of dead (or open) space between areas of dry lift adhesive 34, as discussed below in FIGS. 4A-4C. The high strength of dry lift adhesive 34 will hold confetti pieces 22 in printable sheet 20 as printable sheet 20 passes through a printer.

The pattern of dry lift adhesive 34 allows a corner of confetti pieces 22 to be peeled up and pulled away from backing film layer 36 in an area that has a dead space. Confetti pieces 22 can then be fully removed from printable sheet 20 by pulling confetti pieces 22 off backing film layer 36 along dry lift adhesive 34. Alternatively, the pattern of dry lift adhesive 34 allows backing film layer 36 to be lifted away from printable substrate 32 in an area that has a dead space. Backing film layer 36 can be peeled off printable substrate 32 and confetti pieces 22 can then be removed from printable substrate 32. In alternate embodiments, dry lift adhesive 34 can be applied with varying thicknesses. Areas with a lower thickness will be weak areas where confetti pieces 22 can be separated from backing film layer 36.

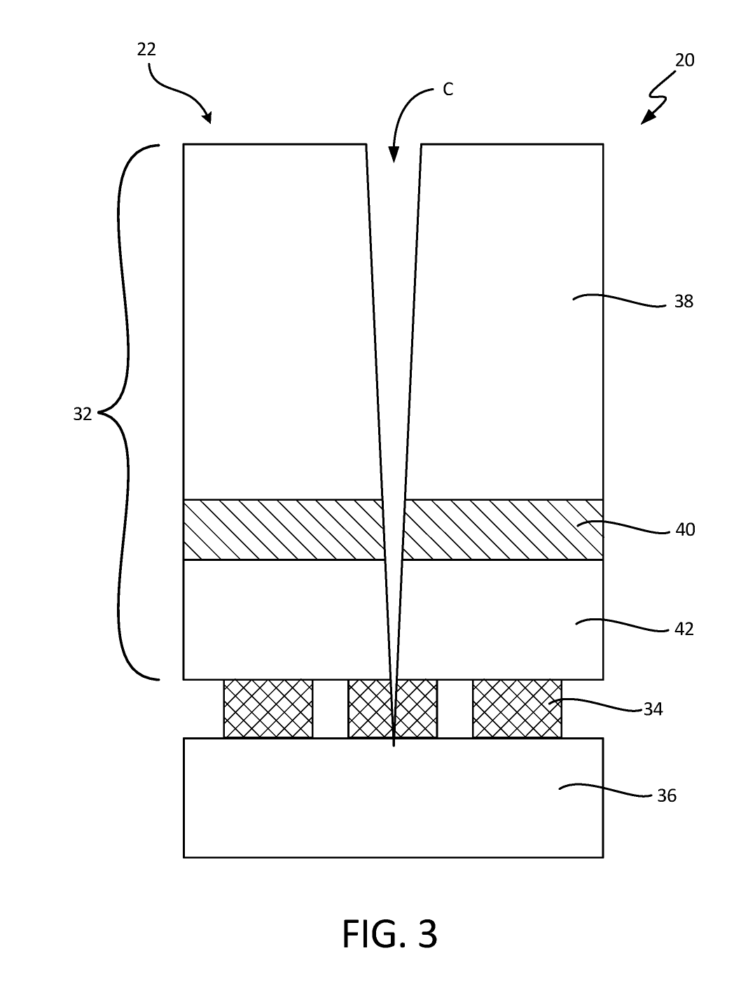

FIG. 3 is a cross-sectional elevation view of a portion of printable sheet 20 after it has been cut. Printable sheet 20 includes confetti pieces 22, printable substrate layer 32, dry lift adhesive 34, backing film layer 36, and cut line C. Printable substrate 32 includes top substrate layer 38, pressure sensitive adhesive 40, and film layer 42.

Printable sheet 20 can be cut with cut line C, as shown in FIG. 3, which splits printable substrate 32. Cut line C extends through printable substrate layer 32 and dry lift adhesive 34. Cut line C can extend a short distance into backing film layer 36, but does not cut through backing film layer 36. Cut line C is formed by die cutting through printable substrate layer 32 and dry lift adhesive 34. This form of cutting through a top layer but not through a bottom layer is known as kiss cutting. Cut line C creates a periphery of confetti pieces 22, allowing them to be cut out of printable substrate 32 while still maintaining backing film layer 36 as a solid layer.

Cutting through printable substrate 32, but not through backing film layer 36 allows printable substrate 32 to be held on printable sheet 20 as printable sheet 20 passes through a printer. After printable sheet 20 passes through a printer, confetti pieces 22 that have been cut from printable substrate 32 of printable sheet 20 can be separated from printable sheet 20 by separating printable substrate 32 from backing film layer 36 along dry lift adhesive 34. Dry lift adhesive 34 has a dry release so neither printable substrate 32 nor backing film layer 36 will have a sticky residue on them after printable substrate 32 is removed from backing film layer 36.

This is advantageous, as it enables confetti pieces 22 to be used as confetti, where this use may not be possible when adhesives that leave sticky residues are used, because the confetti pieces would stick together. Using dry lift adhesive 34 in printable blank sheet 10 is advantageous, as intricately shaped and small objects can be cut into printable substrate 32 and then easily removed from printable substrate 32 after printable blank sheet 10 has been run through a printer. Dry lift adhesives have been previously used with printable blank sheets when simple two-dimensional objects are being formed. A solid layer (known in the art as a flood coat) of the dry lift adhesive can be applied between two layers. In order for the simple two-dimensional structures to be removed, the dry lift adhesive had to have a weak strength so that the objects could be removed. The weak strength of the dry lift adhesive in previous printable blank sheets limited what objects could be cut into the sheet, as the dry lift adhesive was not strong enough to hold complex, small, or intricate designs in the sheet when the sheet was being run through a printer. Thus, sheets were limited to large simple objects with few cut lines, such as rectangular business cards.

Applying dry lift adhesive 34 as a pattern allows dry lift adhesive 34 to have a higher strength than previously used dry lift adhesives. The higher strength dry lift adhesive 34 is capable of holding intricately shaped and small objects with multiple cut lines in printable blank sheet 10 as printable blank sheet 10 is run through a printer. The objects can then be removed from printable blank sheet 10 by separating printable substrate 32 from backing film layer 36 where there is a dead space in dry lift adhesive 34.

In one embodiment, a top side of top substrate layer 38 can have a color that is different from a color of the underside of film layer 42. This way, when confetti pieces 22 are removed from printable sheet 20, each piece will have a different color on each side.

FIGS. 4A-4C show examples of dry lift adhesive 34 being applied in different laminating patterns. FIG. 4A is a plan view of a first embodiment of dry lift adhesive 34 applied in a first laminating pattern. FIG. 4B is a plan view of a second embodiment of dry lift adhesive 34 applied in a second laminating pattern. FIG. 4C is a plan view of a third embodiment of dry lift adhesive 34 applied in a third laminating pattern. FIGS. 4A-4C include dry lift adhesive 34, backing film layer 36, and dead spaces 44. Dry lift adhesive 34 is a dry lift adhesive that is applied in a pattern to facilitate the easy removal of a top layer from backing film layer 36. Dead spaces 44 are the open spaces where dry lift adhesive 34 has not been applied to backing film layer 36.

As seen in FIG. 4A, dry lift adhesive 34 can be applied to backing film layer 36 as a plurality of rings that are spaced apart. Dry lift adhesive 34 comprises the ring portion and dead space 44 is in the center of the ring of dry lift adhesive 34. As seen in FIG. 4B, dry lift adhesive 34 can be applied with voided strips of dead spaces 44. The voided strips of dry lift adhesive 34 can be aligned with edges of confetti pieces 22. As seen in FIG. 4C, dry lift adhesive 34 can be applied as a plurality of V-shaped areas that are arranged in groups of fours and spaced apart creating dead spaces 44 in the center and around each of the plurality of V-shaped areas.

Dead spaces 44 can be positioned between and around laminating patterns of dry lift adhesive 34. When a laminating pattern of dry lift adhesive 34 is used to connect two different layers of materials, dead spaces 44 provide areas where the layers can be pulled apart. This allows a user to separate the layers along dry lift adhesive 34. Dead spaces 44 allow higher strength dry lift adhesive 34 to be used, as dead spaces 44 provide gaps in dry lift adhesive 34 so that different layers can be separated.

Dry lift adhesive 34 can be strategically placed on printable sheet 20 as well. In one embodiment, multiple, small patterns of dry lift adhesive 34 can be applied to each of confetti pieces 22 to further enable effective removal of confetti pieces 22. The use of multiple, small patterns of dry lift adhesive 34 can also help to keep confetti pieces 22 attached to backing film layer 36 during printing.

Applying dry lift adhesive 34 as a pattern allows dry lift adhesive 34 to have a higher strength than previously used dry lift adhesives. The higher strength dry lift adhesive 34 is capable of holding intricately shaped and small confetti pieces 22 with multiple cut lines in printable sheet 20 as printable sheet 20 is run through a printer. Objects with intricate shapes can be objects that include one of the following features: shapes with curved edges; shapes with corners at non-square angles; shapes with edges running neither parallel nor perpendicular to each other; objects with flanges extending outward from a main body portion; objects that are shaped as irregular polygons; objects where at least a portion of the periphery of the object is curved; and objects with scored lines, perforated lines, or die cut lines on a body portion of the object. These complex and intricate shapes remain attached to backing film layer 36 during printing due to the higher strength of the dry lift adhesive 34. Confetti pieces 22 can then be removed from printable sheet 20 by separating printable substrate 32 from backing film layer 36 where there is dead space 44 in dry lift adhesive 34.

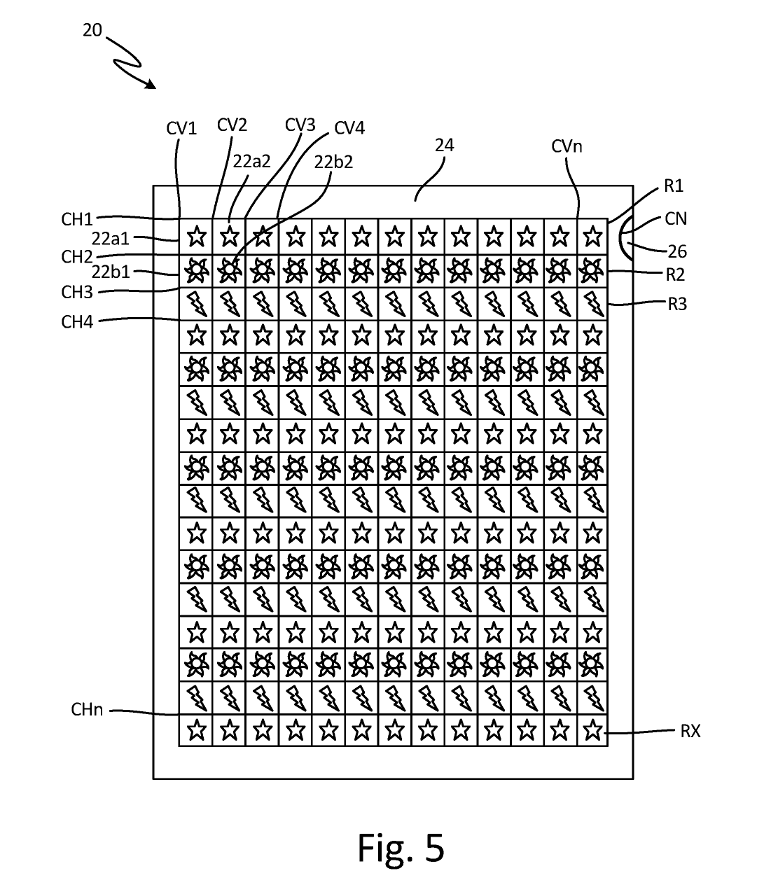

FIG. 5 is a plan view of printable sheet 20 of FIGS. 1-3 with printed images on confetti pieces 22. Printable sheet 20 includes remainder 24, notch 26, notch cut line CN, rows R1-RX, and cut lines C, which include horizontal cut lines CH1-CHN and vertical cut lines CV1-CVn.

Row R1 is a horizontal row of confetti pieces 22a1-22an between horizontal cut lines CH1 and CH2. Each of confetti pieces 22a1-22an in row R1 includes an image of a star printed on its surface (on printable substrate 32). Row R2 is a horizontal row of confetti pieces 22b1-22bn between horizontal cut lines CH2 and CH3. Each of confetti pieces 22b1-22bn in row R2 includes an image of a sun printed on its surface. Row R3 is a horizontal row of confetti pieces 22c1-22cn between horizontal cut lines CH3 and CH4. Each of confetti pieces 22c1-22cn in row R3 includes an image of a lightning bolt printed on its surface.

In the embodiment shown in FIG. 5, rows R1-R3 repeat through row RX. That is, each row of printable sheet 20 is a row of stars, suns, or lightning bolts. In another embodiment, printable sheet 20 can have images that are all the same. In another embodiment, every image on each of confetti pieces 22 can be different. Images printed on confetti pieces 22 are not limited to shapes or designs. For example, pictures of landscapes, vehicles, or people can be printed on confetti pieces 22. Further, text and logos can be printed on confetti pieces 22.

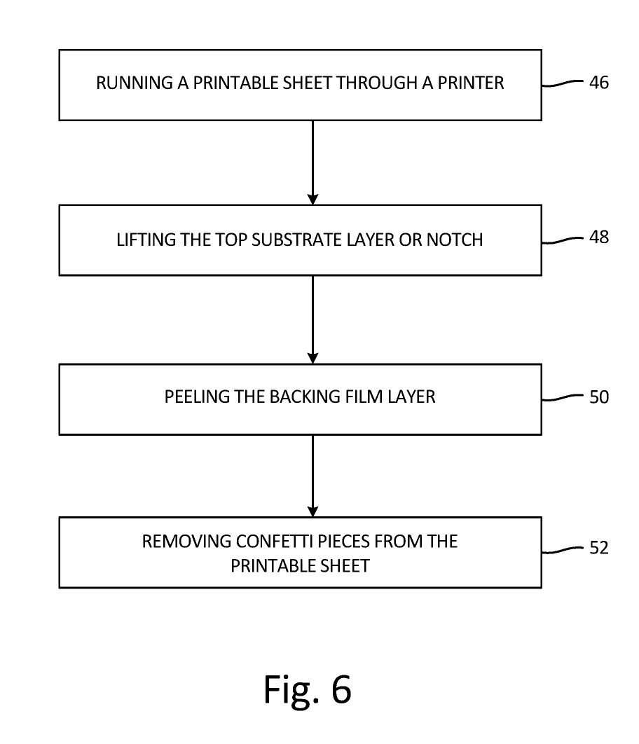

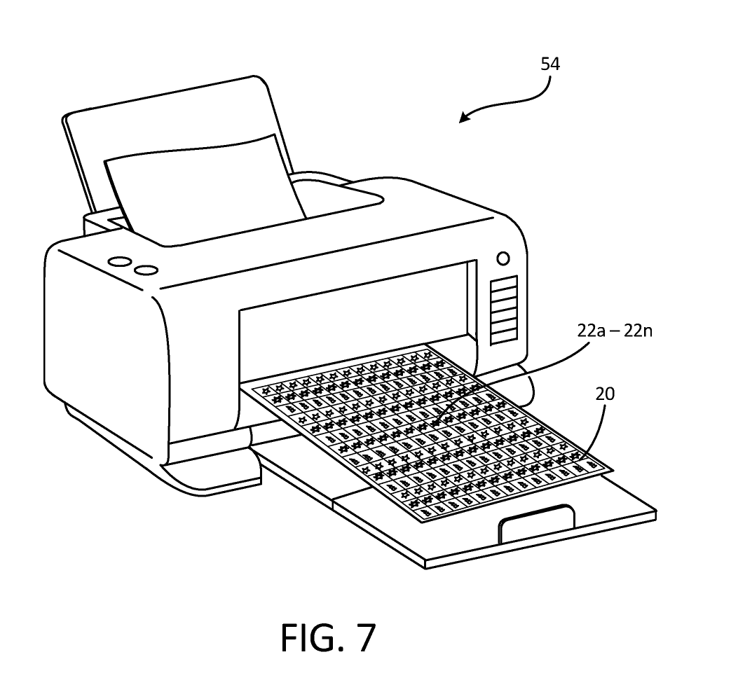

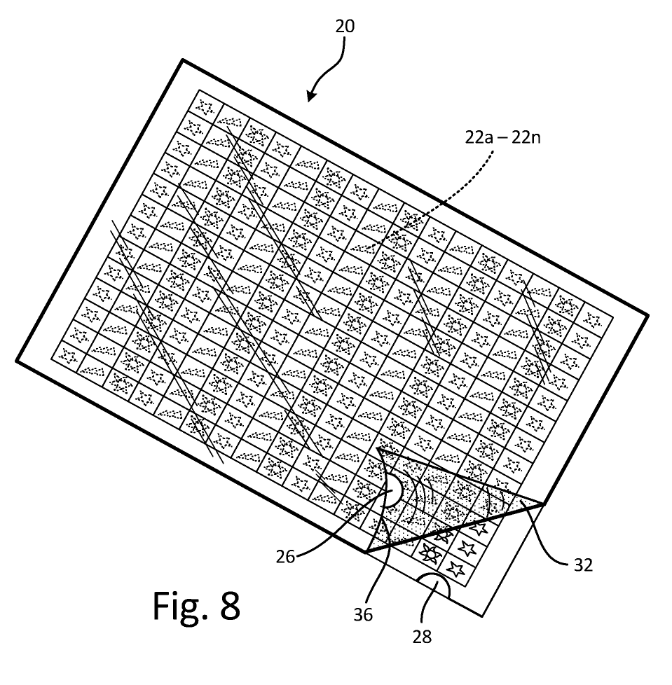

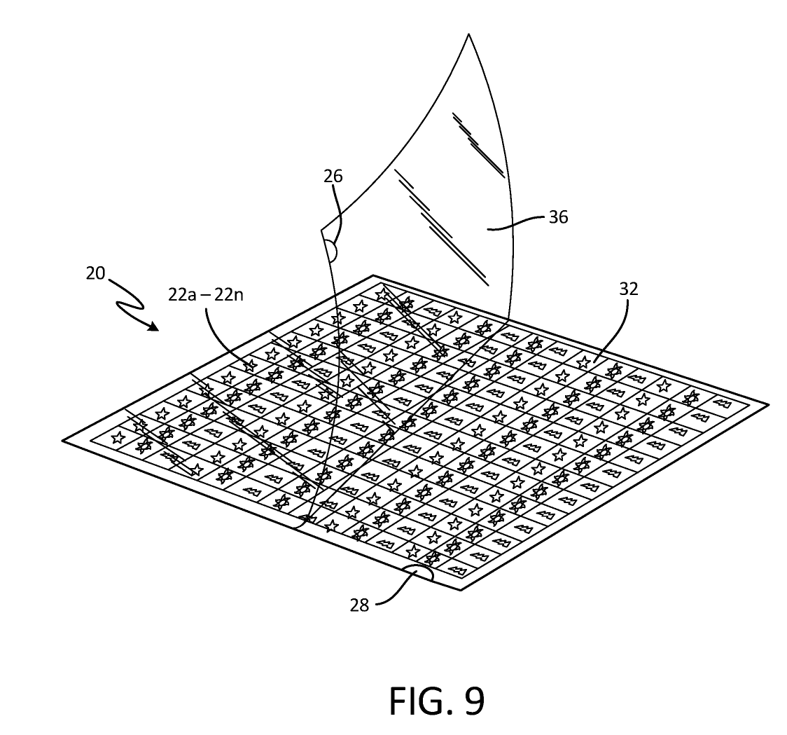

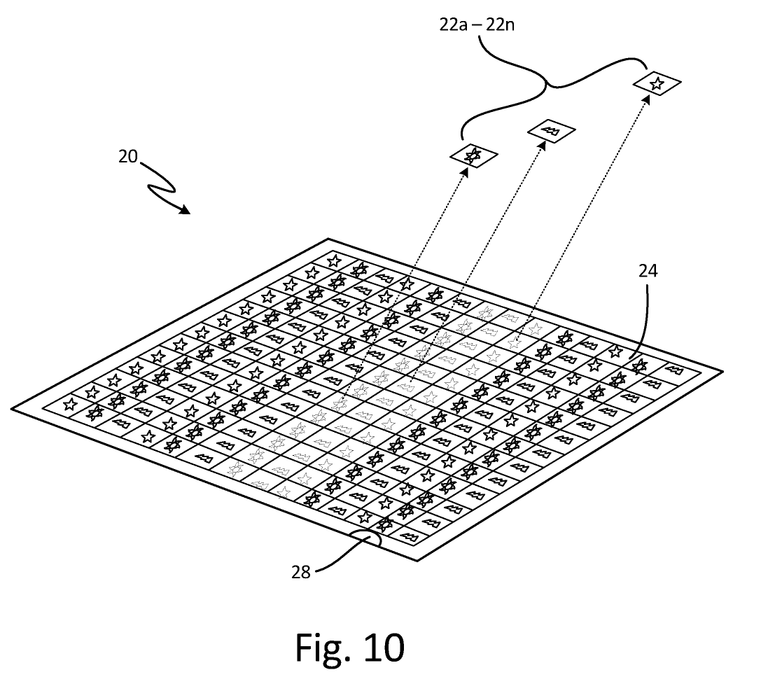

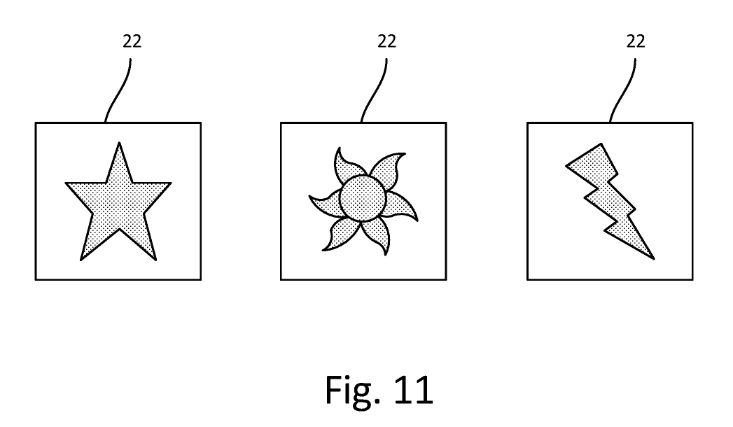

FIG. 6 is a flow chart showing how confetti pieces 22 can be created from printable sheet 20. FIG. 6 includes steps 46, 48, 50, and 52 to show how confetti pieces 22 can be formed. FIGS. 7-10 illustrate each of the steps seen in the flow chart in FIG. 6 and FIG. 11 shows confetti pieces 22 as a product of the steps 46-52. FIG. 7 is a perspective view of printable sheet 20 as it is being run through printer 54. FIG. 8 is a perspective view of printable sheet 20 as a corner of backing film layer 36 is lifted. FIG. 9 is a perspective view of printable sheet 20 as backing film layer 36 is peeled off printable sheet 20. FIG. 10 is a perspective view of printable sheet 20 with backing film layer 36 removed and confetti pieces 22 partially removed from printable sheet 20. FIG. 11 is a plan view of confetti pieces 22 after they have been removed from printable sheet 20.

Step 46 includes running printable sheet 20 through printer 54, as seen in FIG. 7. Printer 54 is a standard printer. Printable sheet 20 can have a thickness between 0.004 inches and 0.018 inches to make printable sheet 20 suitable for being passed through printer 54. Further, printable sheet 20 can have a length and width that allows it to be passed through printer 54. In other embodiments, printable sheet can have a thickness outside the range of 0.004 inches and 0.018 inches.

Confetti pieces 22 are positioned in printable sheet 20. Confetti pieces 22 are cut into printable substrate 32 and are attached to backing film layer 36 with dry lift adhesive 34, as described above. As printable sheet 20 runs through printer 54, confetti pieces 22 are held in printable sheet 20 by dry lift adhesive 34.

Automatic imposition software can be used to create the design that is to be printed on printable sheet 20. The automatic imposition software allows a user to create the design for one confetti pieces 22 and then the design is automatically reproduced to be applied to every confetti pieces 22 in printable sheet 20. The automatic imposition software can orient the design so that it positioned properly on confetti pieces 22 in printable sheet 20. The software can also allow for different images to be printed on different confetti pieces 22, as described above in FIG. 5.

Step 48 includes lifting backing film layer 36 from printable substrate 32 using notch 26, as shown in FIG. 8. FIG. 8 shows printable sheet 20, confetti pieces 22, notch 26, notch cut line CN, printable substrate 32 and backing film layer 36. After a top face of printable sheet 20 has been printed on, a corner of backing film layer 36 can be pulled away from printable substrate 32. Dry lift adhesive 34 holds confetti pieces 22 on backing film layer 36 and is applied as a pattern so that there are areas filled with dry lift adhesive 34 and dead spaces 44, as described in relation to FIGS. 4A-4C above. A corner of backing film layer 36 can be pulled away from printable substrate layer 32 in an area of dead space 44. The dead space 44 creates a gap between confetti pieces 22 and backing film layer 36, as illustrated in FIG. 2. This allows a user to use a finger or any other object to lift a corner of backing film layer 36 from printable substrate 32.

In another embodiment, a user can use notch 26 to lift backing film layer 36 from printable substrate 32. Notch 26 is a portion of printable substrate 32 defined by notch cut line CN, as described above. Notch 26 connects to backing film layer 36 with dry lift adhesive 34, but notch cut line CN separates the portion of printable substrate 32 in notch 26 from remainder 24. This allows a user to grab notch 26 and lift notch 26 together with backing film layer 36 from printable sheet 20, including remainder 24 and confetti pieces 22.

Step 50 includes peeling backing film 36 away from printable substrate 32, as seen in FIG. 9. After a corner of backing film 36 or notch 26 is lifted, a user can grasp that corner or notch 26 and pull backing film layer 36 away from the rest of printable sheet 20. Printable substrate 32 will then be separated from backing film layer 36 along dry lift adhesive 34. A majority of dry lift adhesive 34 will remain on backing film layer 36 when printable substrate is removed from backing film layer 36. Any dry lift adhesive 34 that remains on printable substrate 32 will be undetectable. Further, any dry lift adhesive 34 that remains on either printable substrate 32 or on backing film layer 36 will not be sticky, as dry lift adhesive 34 has a dry release when it is separated.

Step 52 includes removing confetti pieces 22 from remainder 24, as seen in FIG. 10. FIG. 10 includes printable sheet 20, confetti pieces 22, remainder 24 and notch cut line CN. After backing film layer 36 is removed from printable sheet 20, printable substrate 32 remains. Printable substrate 32 includes confetti pieces 22 and remainder 24. Confetti pieces 22 are cut through printable substrate 32 and remainder 24 surrounds confetti pieces 22. Confetti pieces 22 can be easily removed from remainder 24 by simply lifting them out of remainder 24 and separating them from each other.

FIG. 11 is a plan view of confetti pieces 22 after they have been removed from printable sheet 20. Printable sheet 20 is advantageous, as confetti pieces 22 can be created by cutting printable substrate 32 and then separated confetti pieces 22 from backing film layer 36. Creating confetti pieces 22 out of printable substrate 32 using cut lines C, will give confetti pieces 22 smooth edges, as shown in FIG. 11, making confetti pieces 22 more aesthetic and more suitable for use as confetti. Further, cut lines C make removal of confetti pieces 22 from printable sheet 20 easy, as confetti pieces 22 will not tear as they are removed. This is advantageous over previous printable blank sheets that utilized perforations or bridges to separate confetti pieces 22 in sheets.

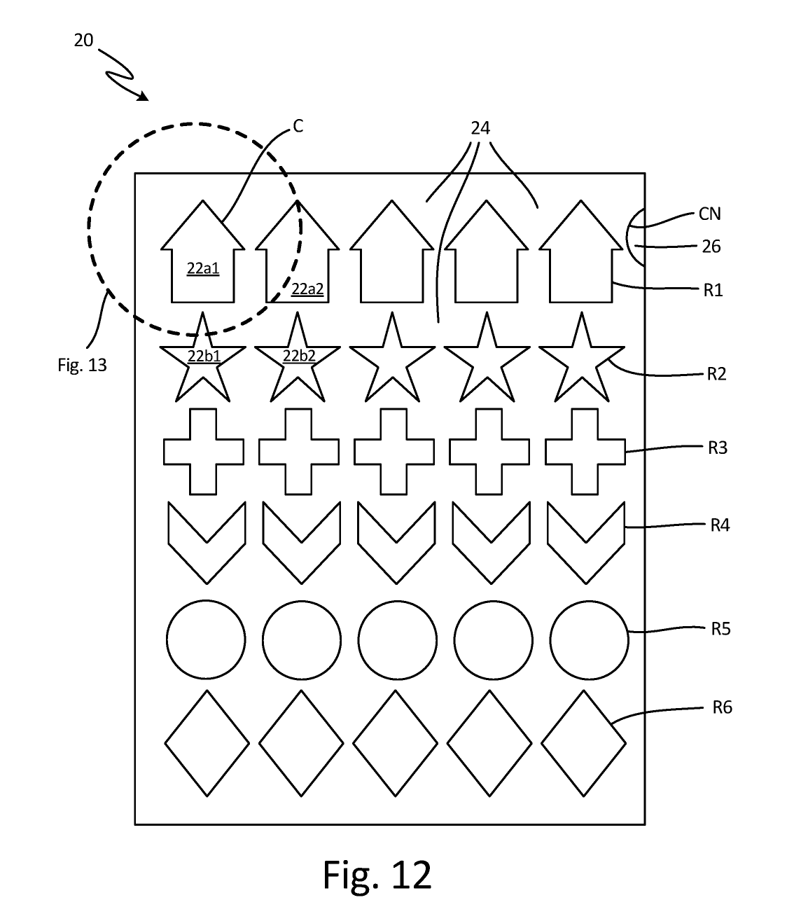

FIG. 12 is a plan view of printable sheet 20, where confetti pieces 22 have different geometric shapes. Printable sheet 20 includes confetti pieces 22, remainder 24, notch 26, notch cut line CN, cut lines C, and rows R1-R6.

Printable sheet 20 is constructed consistently with FIGS. 1-3, except that cut lines C have create a periphery of each of confetti pieces 22 in various geometric shapes. Cut lines C do not meet or intersect. Because of this, remainder 24 accounts for more surface area of printable sheet 20 than that of printable sheet 20 shown in FIG. 1. Also, because cut lines C do not meet, when backing film 36 is separated from printable substrate 32, confetti pieces 22 of printable sheet 20 must be individually separated from remainder 24. In another embodiment, cut lines C can touch each other, without crossing, reducing remainder 24, and allowing more confetti pieces 22 to fit onto printable sheet 20.

Each of rows R1-R6 contains a row of confetti pieces 22 having a different geometric shape. Row R1 contains confetti pieces 22 in the shape of a simple two-dimensional house. Row R2 contains confetti pieces 22 in the shape of a star. Row R3 contains confetti pieces 22 in the shape of a plus sign or cross. Row R4 contains confetti pieces 22 in the shape of a chevron. Row R5 contains confetti pieces 22 in the shape of a circle. Row R6 contains confetti pieces 22 in the shape of a rhombus (diamond). In other embodiments, cut lines C can form fewer or more geometric shape variations on printable sheet 20. Also, shapes do not have to vary by row. For example, in another embodiment, row R1 can contain confetti pieces having geometric shapes of a house, a star, and a rhombus. Confetti pieces 22 can also be arranged irregularly on printable sheet 20. For example, confetti pieces 22 can be arranged to minimize the area of remainder 24.

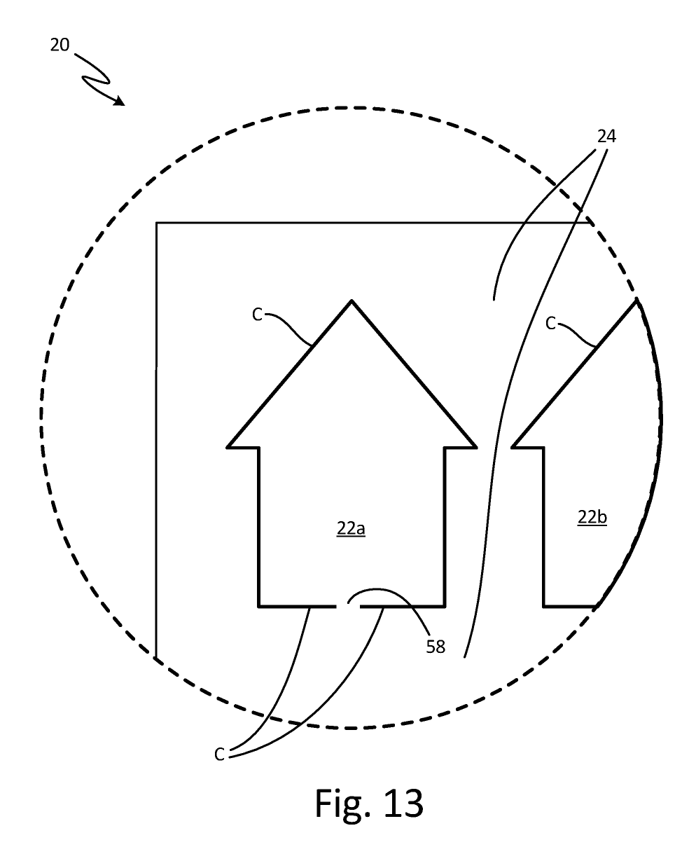

FIG. 13 is a close-up plan view of a portion of printable sheet 20 of FIG. 13 showing tie 58 connecting confetti piece 22a1 to remainder 24. Printable sheet 20 includes confetti pieces 22a1 and 22a2, remainder 24, tie 58, and cut lines C.

Cut lines C create confetti pieces 22a1 and 22a2, by defining a periphery of confetti pieces 22a1 and 22a2, as described in previous embodiments. However, in the embodiment shown in FIG. 13, cut lines C do not define the entire periphery of confetti pieces 22a1 and 22a2. For example, cut line C extending along a bottom of the house shaped confetti is interrupted by tie 58. Tie 58 is a portion of printable substrate 32 that connects confetti piece 22a1 to remainder 24. In another embodiment, confetti pieces 22 may have a plurality of ties 58.

Tie 58 has several benefits. For example, tie 58 can hold confetti pieces 22 in place as they pass through a printer. Because of this, a weaker dry lift adhesive can be used to secure confetti pieces 22 to backing film layer 36. While tie 58 is strong enough to hold confetti pieces 22 during printing, tie 58 can be small enough so that it is easily broken, allowing relatively fast and simple removal of confetti pieces 22 from remainder 24. Also, by using a single, or few ties 58, confetti pieces 22 can be held in printable sheet 20 without greatly affecting the aesthetics of the perimeter or outline of each of confetti pieces 22.

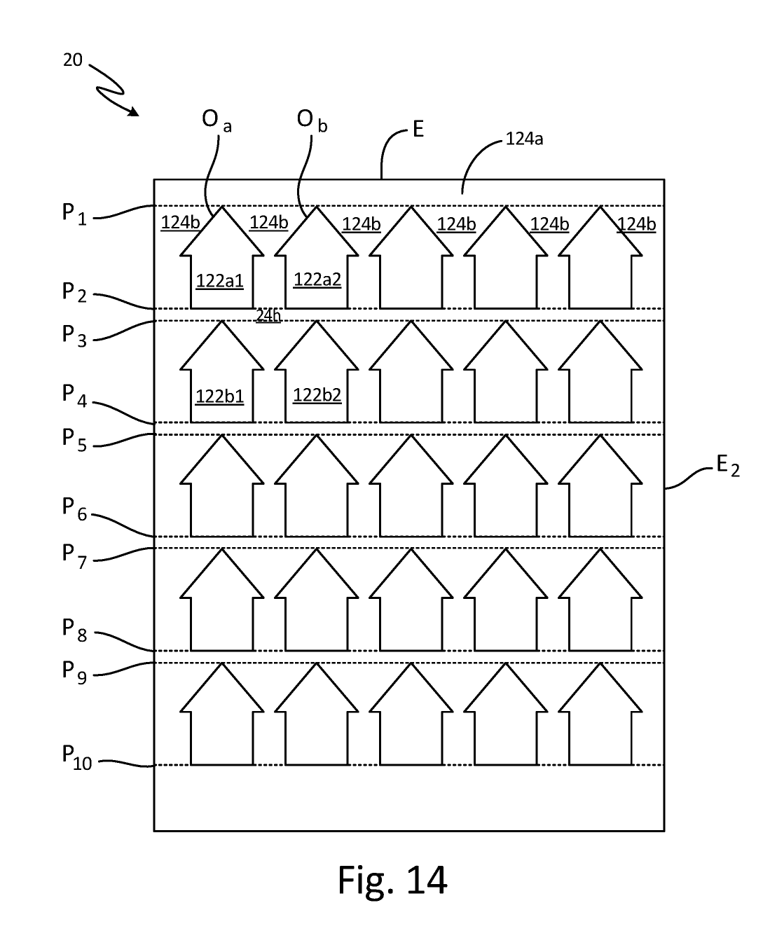

FIG. 14 is a plan view of a second embodiment of a printable sheet, printable sheet 120, that is printable on both sides. Printable sheet 120 includes confetti pieces 122, remainder pieces 124a-124n, outline perforations Oa-On, run-out perforations P (P1, P2, P3, P4, P5, P6, P7, P8, P9, and P10). Also shown are edges E1-E4. Confetti pieces 22 include rows of confetti pieces (122a1-122an, 122b1-122bn, 122c1-122cn, 122d1-122dn, and 122e1-122en).

Run-out perforations P run longitudinally (parallel to edges E1 and E3) across printable sheet 120 from edge E4 to edge E2. Run-out perforations P can be of any suitable weight, including micro-perforations, which can create a reduced strength of the run-out perforations P. Outline perforations O surround the periphery of, and define confetti pieces 122 on printable sheet 120. Outline perforations O can be of any suitable weight, including micro-perforations, which can create a reduced strength of the run-out perforations. Confetti pieces 122 are capable of being printed on without printing on the run-out perforations P or outline perforations O. The reverse side of printable sheet 120 is the same as the side pictured in FIG. 14.

Each run-out perforation P is aligned with one of outline perforations O. Connecting each run-out perforation P with outline perforations O allows a user to bend printable sheet 120 along run-out perforations P without creating unwanted fold lines across printable sheet 120. The only fold lines that will be made when bending run-out perforations P are folds along outline perforations O, which will be folded regardless. Folding run-out perforations P will weaken them and allow for easier detachment of confetti pieces 122 from printable sheet 120.

Surrounding confetti pieces 122 are remainder pieces 124a-124n. For example, remainder pieces 124a, 124b, 124c, and 124h surround confetti piece 122a1. Remainder pieces 124a-124n are outlined by edges E1-E4, outline perforations O, or run-out perforations P. Remainder pieces 124a-124n are expendable parts of printable sheet 120 that can be discarded when confetti pieces 122 are removed from printable sheet 120.

In use of one embodiment, printable sheet 120 can be run through a printer or copier to have an image printed on a first side of confetti pieces 122. Then, in one embodiment, the printable sheet can be run through a printer a second time to have an image printed on a second side of confetti pieces 122. The first and second side of confetti pieces 122 can receive the same image or different images. In another embodiment, sheet 120 can be run through a printer capable of printing on both sides of printable sheet 120 in a single pass.

After printing, printable sheet 120 can be folded along run-out perforations P. When folded, run-out perforations P will weaken and separate easily. This allows some of remainder pieces 124a-124n to be disconnected from one another and from confetti pieces 122. Any of remainder pieces 124a-124n still attached to printable sheet 120 can be folded along outline perforations 120 surrounding confetti pieces 122. The sheet can then be flattened and remainder pieces 124a-124n can be folded in the opposite direction of the first folding, as described above, allowing confetti pieces 122 to break apart from the remainder pieces. Confetti pieces 122 will then be free-standing, defined by outline perforations O.

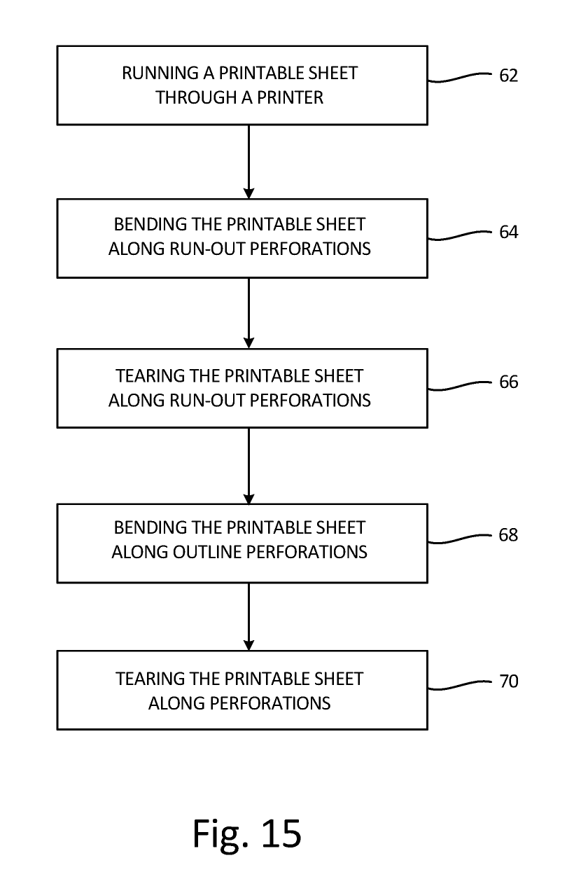

FIG. 15 is a flow chart showing how confetti pieces 22 can be created from the printable sheet 120. Steps 62, 64, 66, 68 and 70 show how a user can create their own custom confetti pieces 122 from printable sheet 120.

Step 62 includes running a printable sheet through a printer. The printable sheet can be made of paper, plastic, or any other suitable material that is capable of being printed on. The printable sheet will include the outline of confetti pieces defined by perforated lines and will have run-out perforations running from one side of the sheet to the other side. Both the outline perforations and the run-out perforations can be of any suitable weight. The printable sheet can be supplied to the user with perforations from a manufacturer. The printable sheet will also have areas that are capable of being printed on so that confetti pieces can be custom printed. Prior to printing on the sheet, a template on a computer can be used to create the custom image that is to be printed on the sheet. In one embodiment, step 62 can include running the printable sheet through a printer a second time so the printable sheet receives printed material on both sides of the printable sheet.

Printable sheet 120 can have a thickness between 0.004 inches and 0.018 inches to make printable sheet 120 suitable for being passed through a standard printer. Further, printable sheet 120 can have a length and width that allows it to be passed through a standard printer. In other embodiments, printable sheet can have a thickness outside the range of 0.004 inches and 0.018 inches.

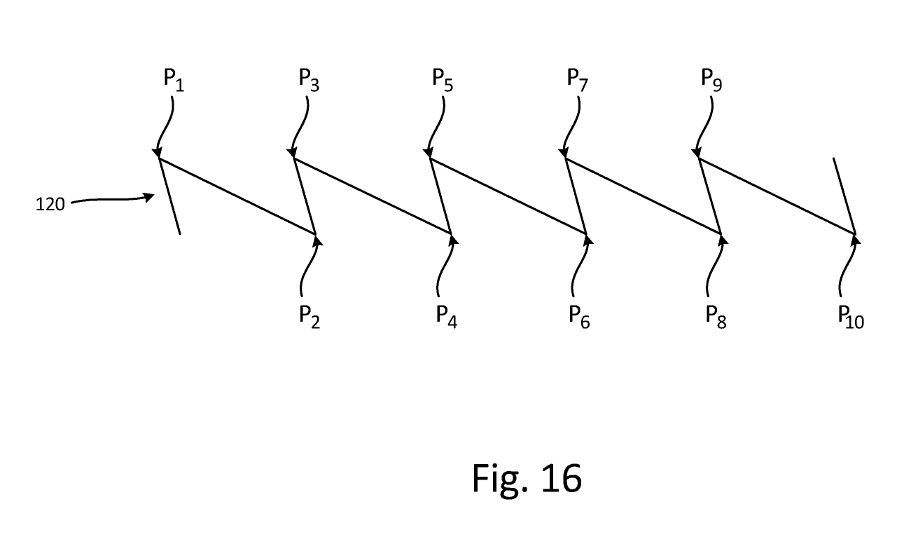

Step 64 includes bending the printable sheet along run-out perforations that run from one side of the sheet to the other side of the sheet. The sheet can be folded along the run-out perforations in an alternating manner, so that the resulting folded structure resembles a fan, or accordion-shape, as shown in FIG. 16 below. The sheet can then be flattened out and folded along the run-out perforations in the opposite direction, again resembling a fan structure when completely folded. The sheet should then once again be flattened out, allowing the run-out perforations to break apart.

Step 66 includes tearing the printable sheet along the run-out perforations. After bending the printable sheet in two directions along the run-out perforations and flattening the sheet, the run-out perforations can begin to separate. Then, a user can grasp the remainder pieces of the printable sheet and tear the printable sheet along the run-out perforations, allowing the remainder pieces to be removed and discarded.

Step 68 includes bending the printable sheet along the outline perforations. As stated above, the periphery of confetti pieces can be defined by a set of outline perforations. Any remainder pieces still attached to the printable sheet can be folded along the outline perforations surrounding the confetti pieces. The sheet can then be flattened and the remainder pieces can be folded in the opposite direction of the first folding, as described above, allowing the confetti pieces to break apart from the remainder pieces.

Step 70 includes tearing the printable sheet along the outline perforations. After bending the printable sheet in two directions along the outline perforations and flattening the sheet, the outline perforations can begin to separate. Then, a user can grasp the remainder pieces of the printable sheet and the confetti pieces and tear the printable sheet along the outline perforations, allowing the remainder pieces to be removed and discarded, leaving the confetti pieces.

This method provides an efficient and effective way to create custom confetti with custom images from printable sheets. Using this method, businesses and users will be able to create custom confetti pieces at a lower cost and in a time-efficient manner. This method increases the incentive for businesses to create their own custom print confetti pieces by providing presentable and aesthetic final products.

FIG. 16 is an elevation view of the second embodiment of printable sheet 120 when it is partially folded along run-out perforations P (P1, P2, P3, P4, P5, P6, P7, P8, P9, and P10). Each run-out perforation P runs from one side of printable sheet 120 to the other side and is interrupted, or defines a portion of the periphery of confetti pieces 122. Run-out perforations P partially define remainder pieces 124a-124n that are to be detached from confetti pieces 122.

As described above, a user can fold printable sheet 120 along each of run-out perforations P to create an accordion-like shape, as shown in FIG. 16. A user can then flatten printable sheet 120, and then fold sheet 120 along run-out perforations P in the opposite direction, allowing remainder pieces 124a-124n to break apart from each other and confetti pieces 122. This process allows a user to quickly separate a high quantity of confetti pieces 122 from a remainder of printable sheet 120. Separating printable sheet 120 along run-out perforations P allows confetti pieces 122 to easily separate from printable sheet 120 without tearing. This creates stronger and more presentable final product of confetti pieces 122.

In another embodiment, printable sheet 120 can be formed in any geometric shape, such as a square or a hexagon.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A printable sheet including a plurality of confetti pieces, the printable sheet comprising:
a printable substrate layer;
a backing film layer;
a dry lift adhesive layer connecting the printable substrate layer to the backing film layer, wherein the backing film layer can be separated from the printable substrate layer along the dry lift adhesive layer; and
cut lines extending through the printable substrate layer and the dry lift adhesive layer but not through the backing film layer, wherein the cut lines define confetti pieces.

2. The printable sheet of claim 1 and further comprising a notch cut into the printable substrate layer adjacent an edge of the printable sheet.

3. The printable sheet of claim 1, wherein the cut lines define an entire periphery of each of the confetti pieces.

4. The printable sheet of claim 1, wherein the cut lines define an incomplete periphery of the confetti pieces, creating a tie connecting each confetti piece to one of a remainder of the printable substrate layer or an adjacent confetti piece.

5. The printable sheet of claim 1, wherein the printable substrate layer comprises a first side and a second side, wherein the first side is configured to receive a printed image, and the second side is connected to the dry lift adhesive layer, and wherein the second side has a color that is different from a color of the first side.

6. The printable sheet of claim 1, wherein the printable substrate layer comprises a first side and a second side, wherein the first side is configured to receive a printed image, and the second side is connected to the dry lift adhesive layer, and wherein the second side has a color that is the same as a color of the first side.

7. The printable sheet of claim 1, wherein the dry lift adhesive is applied in a pattern.

8. The printable sheet of claim 7, wherein the dry lift adhesive pattern is a voided pattern with areas covered with dry lift adhesive and areas that are open space.

9. The printable sheet of claim 1, wherein the printable substrate layer has a thickness between 0.004 inches and 0.018 inches.

10. The printable sheet of claim 1, wherein the bottom film layer has a thickness between 0.0005 inches and 0.004 inches.

11. The printable sheet of claim 1, wherein the bottom film layer is comprised of one of polypropylene, polyethylene, polyester, or polyvinyl chloride.

12. The printable sheet of claim 1, wherein the dry lift adhesive has a high strength.

13. A printable sheet including a plurality of confetti pieces, the printable sheet comprising:
a first printable side and a second printable side;
outline perforations extending through the printable sheet, wherein the outline perforations define confetti pieces; and
run-out perforations extending from the outline perforations to edges of the printable sheet.

14. The printable sheet of claim 13, wherein the printable sheet is made of paper or plastic.

15. The printable sheet of claim 13, wherein the outline perforations are micro-perforations with reduced strength.

16. The printable sheet of claim 13, wherein the run-out perforations are micro-perforations with reduced strength.

17. The printable sheet of claim 13, wherein the printable sheet has a thickness between 0.004 inches and 0.018 inches.

18. A method of creating confetti pieces using a printable sheet, the method comprising:
running a printable sheet through a printer, wherein the printable sheet includes a printable substrate layer that is attached to a backing film layer with a dry lift adhesive, wherein the sheet has cut lines extending through the printable substrate layer and the dry lift adhesive layer but not through the backing film layer, and wherein the cut lines define confetti pieces that receive printed material from the printer;
lifting a notch of the printable substrate layer adjacent an edge of the printable sheet, wherein the notch is connected to the backing film layer; and
peeling the backing film layer and dry lift adhesive away from the printable substrate layer, separating the confetti pieces from one another.

19. The method of claim 18, wherein the printable substrate layer comprises a first side and a second side, wherein the first side is configured to receive a printed image, and the second side is connected to the dry lift adhesive layer, and wherein the second side has a color that is different from a color of the first side.

20. The method sheet of claim 18 and further comprising:
breaking a tie connecting a confetti piece to one of a remainder of the printable substrate layer or an adjacent confetti piece, which separates the confetti piece from one of the remainder of the printable substrate layer or the adjacent confetti piece.

21. A method of creating confetti pieces using a printable sheet, the method comprising:
running a printable sheet through a printer, the printable sheet including a first printable side and a second printable side, including outline perforations through the printable sheet that define confetti pieces, and including run-out perforations extending from the outline perforations to edges of the printable sheet;
bending the printable sheet along the outline perforations; and
tearing the printable sheet along the outline perforations causing the confetti pieces to separate from one another.

22. The method of claim 21 and further comprising bending the printable sheet along the run-out perforations.

23. The method of claim 21 and further comprising tearing the printable sheet along run-out perforations to separate the confetti pieces from a remainder of the substrate layer.
